(19) United States
(12) Patent Application Publication
(10) Pub. No.: US 2017/0233184 A1
(43) Pub. Date: Aug. 17, 2017

(54) WASTE COLLECTION SYSTEM AND METHOD

(71) Applicant: Wal-Mart Stores, Inc., Bentonville, AR (US)

(72) Inventors: Yurgis Mauro Bacallao, Centerton, AR (US); Stephen Tyler Caution, Bentonville, AR (US)

(21) Appl. No.: 15/425,287

(22) Filed: Feb. 6, 2017

Related U.S. Application Data
(60) Provisional application No. 62/295,866, filed on Feb. 16, 2016.

(51) Int. Cl. B65F 1/14; B65F 1/08; A47B 88/487; A47B 88/994; A47F 9/04; A47B 95/02

(52) U.S. Cl. CPC B65F 1/1426; A47F 9/04; A47B 95/02; A47B 88/487; A47B 88/994; B65F 1/085; A47F 2009/041; A47B 2095/024; A47B 2095/026; A47B 2210/0032

(57) ABSTRACT

A garbage collection system comprises a housing positioned under a belt of a point of sale register counter; first and second bins positioned in the housing under the point of sale register counter, the first bin for receiving garbage and/or recyclables, the second bin for receiving hangers; and at least one sliding rail extending perpendicular from a height of the housing, the first and second bins coupled to the at least one sliding rail, at least one of the first and second bins retracting or protruding from at least a portion of the housing in a first position and positioned entirely in the housing in a second position.

### RELATED APPLICATIONS

This application claims priority to U.S. Provisional Patent Application Ser. No. 62/295,866, filed on Feb. 16, 2016 entitled “WASTE COLLECTION SYSTEM AND METHOD,” the entirety of which is incorporated by reference herein.

### FIELD

The present inventive concepts relate generally to garbage collection, and more specifically, to the separation of recyclable waste from other garbage at a retail establishment.

### BACKGROUND

Modern stores are environmentally conscious and institute policies or procedures to implement steps to improve the environment.

### BRIEF SUMMARY

In one aspect, provided is a garbage collection system, comprising: a housing positioned under a belt of a point of sale register counter; first and second bins positioned in the housing under the point of sale register counter, the first bin for receiving garbage and/or recyclables, the second bin for receiving hangers; and at least one sliding rail extending perpendicular from a height of the housing, the first and second bins coupled to the at least one sliding rail, at least one of the first and second bins retracting or protruding from at least a portion of the housing in a first position and positioned entirely in the housing in a second position.

In some embodiments, the housing includes: a first side; a second side; a back wall between the first side and the second side; and an interior between the first side, the second side, and the back wall, wherein the first and second bins are positioned in the interior of the housing.

In some embodiments, the garbage collection system further comprises a door at an opening to the interior of the housing.

In some embodiments, the door has at least one of a same or similar color, texture, quality, or material as the sale register counter.

In some embodiments, the garbage collection system further comprises a pair of sliding rails coupled between the door and the housing, for extending or retracting the door and the first and second bin relative to the housing.

In some embodiments, the door is hinged to the housing, which when closed, hides the first and second bins in the housing.

In some embodiments, the garbage collection system further comprises a trash bin housing unit for holding the first and second bins, the trash bin housing unit constructed and arranged for positioning in an interior of the housing.

In some embodiments, the garbage collection system further comprises a frame for holding the first and second bins, the frame constructed and arranged for positioning in an interior of the housing.

In some embodiments, the garbage collection system further comprises at least one fixture attachment for coupling the housing to the register counter.

In some embodiments, the at least one fixture attachment includes a first fixture attachment extending from a top surface of a back wall of the housing.

In some embodiments, the garbage collection system further comprises the at least one fixture attachment includes a second fixture attachment extending from a surface of a side wall of the housing.

In some embodiments, the housing is coupled to an underside of the register counter and is suspended above the ground by a predetermined distance.

In one aspect, provided is a garbage collection system, comprising: a housing positioned under a belt of a point of sale register counter, the housing including a first region for holding a first bin and a second region for holding a second bin; at least one sliding rail extending perpendicular from a height of the housing; and a housing unit or a frame coupled to the at least one sliding rail for holding the first and second bins, the housing unit or frame holding the first and second bins retracting or protruding from at least a portion of the housing in a first position and positioned entirely in the housing in a second position.

In some embodiments, the first bin is constructed and arranged for receiving at least one of garbage or recyclable material, and the second bin is constructed and arranged for receiving hangers.

In some embodiments, the housing includes: a first side; a second side; a back wall between the first side and the second side; and an interior between the first side, the second side, and the back wall, wherein the first and second bins are positioned in the interior of the housing.

In some embodiments, the garbage collection system further comprises a door at an opening to the interior of the housing.

In some embodiments, the housing is coupled to an underside of the register counter and is suspended above the ground by a predetermined distance.

In some embodiments, the garbage collection system further comprises a trash bin housing unit for holding the first and second bins, the trash bin housing unit constructed and arranged for positioning in an interior of the housing.

In some embodiments, the garbage collection system further comprises a frame for holding the first and second bins, the frame constructed and arranged for positioning in an interior of the housing.

In another aspect, provided is a garbage collection system formed by a process, comprising: positioning a housing under a belt of a point of sale register counter; coupling at least one sliding rail to the register counter, the at least one sliding rail constructed and arranged to extend perpendicular from a height of the housing; coupling a housing unit or a frame coupled to the at least one sliding rail for holding the first and second bins; and retracting or extending the housing unit or frame from at least a portion of the housing in a first position and positioned entirely in the housing in a second position.

### BRIEF DESCRIPTION OF THE SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale, emphasis instead being placed upon illustrating the principles of the concepts.

FIG. 1A is a perspective view of a garbage collection system in an open position, in accordance with some embodiments.

FIG. 1B is a perspective view of the garbage collection system of FIG. 1A in a closed position, in accordance with some embodiments.

FIG. 1C is a top view of the garbage collection system of FIGS. 1A and 1B.

FIG. 2 is view of an interior of a garbage collection system, in accordance with some embodiments.

FIGS. 3A and 3B are perspective views of a retail store checkout counter including a garbage collection system in open and closed positions, respectively, in accordance with some embodiments.

### DETAILED DESCRIPTION

One desired procedure by retail establishments is to require store associates to separate garbage from recyclable material such as metal hangers, plastic bags, and so on at a checkout register or other point of sale location.

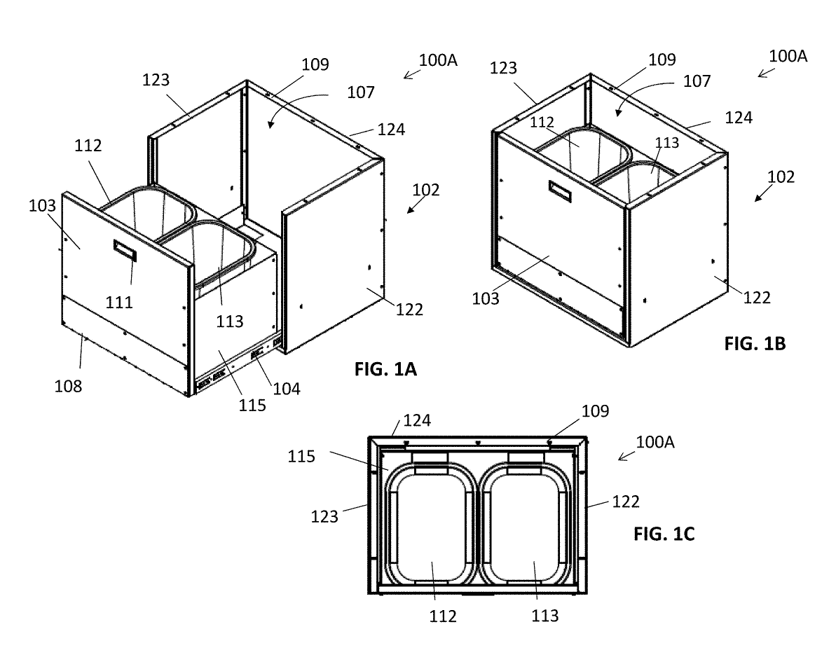

FIG. 1A is a perspective view of a garbage collection system 100A in an open position, in accordance with some embodiments. FIG. 1B is a perspective view of the garbage collection system 100A of FIG. 1A in a closed position, in accordance with some embodiments. FIG. 1C is a top view of the garbage collection system 100A of FIGS. 1A and 1B.

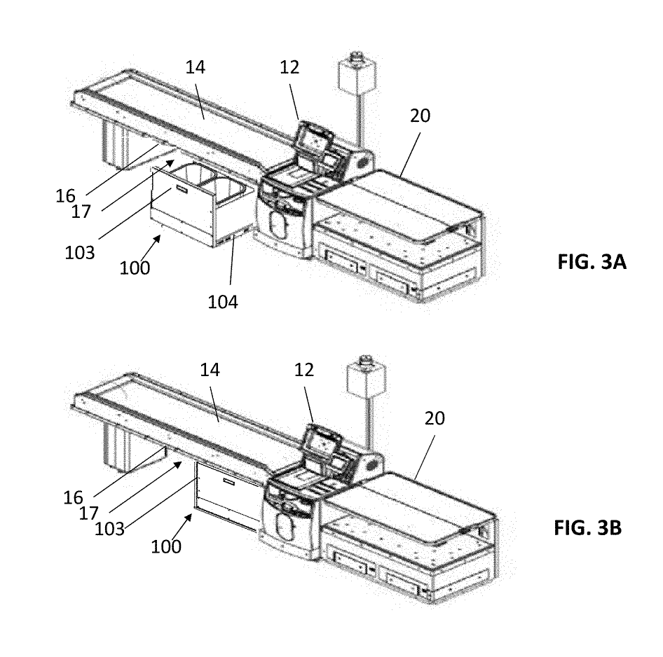

The garbage collection system 110A may be a self-contained unit, for retrofitting or otherwise installing the entire unit under a register belt area (shown in FIGS. 3A and 3B). The garbage collection system 100A includes a housing portion 102 comprising a first side 122, a second side 123, and a back wall 124 collectively forming an interior 107. A door 103 is positioned at an opening to the interior 107 of the housing portion 102. The door 103 may include a handle 111 for opening and/or closing the door 103. In a closed position as shown in FIGS. 1B and 1C, the door 103 may abut edges of the first side 122 and 123, respectively. At least a portion of the door 103 may include a layer or coating of material 108, such as metal, plastic, or chemical compound, for example, providing a scratch or damage-resistant guard.

The housing portion 102 and door 103 may be formed of one or more materials sufficient for supporting the weight of garbage bins 112, 113 and their contents, for example, wood, metal, plastic or related composites, or a combination thereof. The housing portion 102 and/or door 103 may be coated with a material to match the color, texture, material, and/or other features of the checkout counter to which the housing portion 102 is coupled.

The garbage collection system 100A may include a rail system, or set of rails 104, ball bearing slides, or the like, for permitting a trash bin housing unit 115 and door 103 to slide linearly relative to the interior 107 of the housing portion 102. The rails 104 may be formed of metal and/or other material with withstanding the weight of one or both garbage bins 112, 113 filled with trash, recyclable material, and so on. The garbage bins 112, 113 may be positioned in the trash bin housing unit 115, which turn is positioned on the pair of sliding rails 104, so that the trash bin housing unit 115 extends and retracts when needed. For example, when retracted, the trash bin housing unit 115 is positioned in the interior 107 of the housing portion 102. The walls 122-124 of the housing portion 102 are attached under a register belt to a checkout counter (see FIGS. 3A and 3B) which supports the housing portion 102. When extended, the garbage bins 112, 113 are exposed so that trash, recyclable materials, and so on may be placed in the garbage bins 112, 113. One of the garbage bins 112, 113 may provide a compartment for holding trash and the other of the bins 112, 113 may provide a compartment for holding empty hangers and/or other recyclable material. The garbage bins 112, 113 may be off-the-shelf garbage cans, pails, buckets, or other holding accessory, for example, formed of plastic, stainless steel, or other well-known materials. Although two bins 112, 113 are shown and described, other embodiments include a single bin, or more than two bins. The bins 112, 113 may be the same size or be of different sizes.

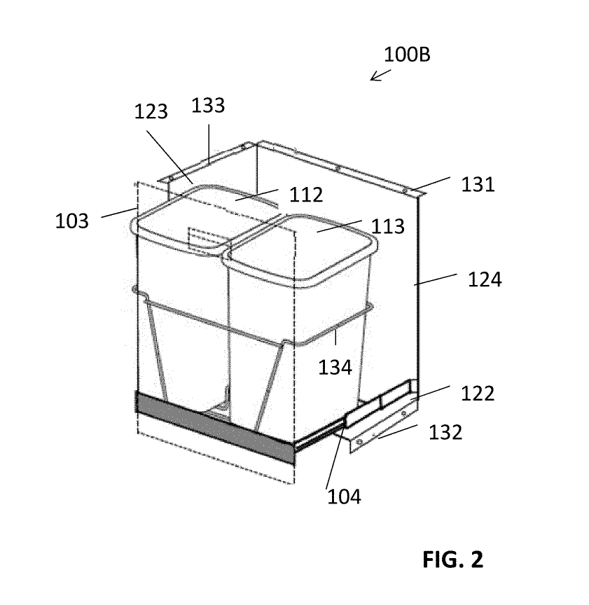

FIG. 2 is view of an interior of a garbage collection system 100B, in accordance with some embodiments. The garbage collection system 100B may have elements similar to those of the garbage collection system 100A of FIGS. 1A-1C, which are not repeated due to brevity.

The garbage collection system 100B may include components that are different than those described with respect to the garbage collection system 100A of FIG. 1. For example, the garbage collection system 100B can include a wire or metal frame 134 instead of the trash bin housing unit 115 of FIG. 1. The frame 134 may be formed of metal, plastic, and/or other composite material providing strength and stability for maintaining at least one bin 112, 113. In some embodiments, the garbage collection system 100B has a door 103 positioned in front of the wire frame 134 to cover the garbage bins 112, 113 when in a closed position, for example, see FIG. 1B. The wire frame 134 may be is positioned on sliding rails 104 or the like, so that the wire frame 134 and the door 103 extend and retract when needed.

The garbage collection system 100B includes fixture attachments 131, 132, 133 for coupling to a register belt region of a retail store checkout counter. In some embodiments, although not shown, the garbage collection system 100A of FIG. 1 may include similar or same fixture attachments. In particular, fixture attachment 131 may extend from a top surface of the back wall 124 of the garbage collection system 100B, fixture attachment 132 can extend from a bottom surface of the first side wall 122 of the garbage collection system 100B, and fixture attachment 133 can extend from a top surface of the second side wall 133 of the garbage collection system 100B. Coupling devices such as screws or the like can be used for attaching the fixture attachments 131, 132, 133 directly to the register belt region. For example, fixture attachment 131 at a top surface of the back wall 124 may be aligned with a screw hole 109 (see FIG. 1A) whereby a screw, nail, or other coupling mechanism may be inserted through a hole in the fixture attachment 131 and into the screw hole 109 for securing the fixture attachment 131 to the back wall 124. Accordingly, when the fixture attachments 131, 133 abut the underside of the cabinet at which the register belt region is located, and/or a side wall of the register belt region, then the cabinet, or housing portion 102 of the garbage collection system 100A, 100B (generally, 100) is suspended, i.e., the bottom of the housing portion 102 does not touch the ground. In other embodiments, attachment 132 may be coupled to the bottom of the cabinet so that the housing portion 102 touches the ground, or more specifically, directly abuts the bottom or floor of the cabinet instead of or in addition to the sidewall of the register belt cabinet.

FIGS. 3A and 3B are perspective views of a retail store checkout counter 16 having a register belt 14, and further including the garbage collection system 100A of FIG. 1A-1C or the garbage collection system 100B of FIG. 2, or other related garbage collection system under the register belt area 14, in accordance with some embodiments. In FIG. 3A, the garbage collection system 100 is in a closed or retracted position. In FIG. 3B, the garbage collection system 100 is in an open or extended position.

The retail store checkout counter 16 may support a plurality of well-known electronic and/or mechanical devices used by a store associate at a checkout counter, for example, but not limited to, a point of sale (POS) terminal or related computer having a display, processor, memory, input/output devices, and so on, optical bar code scanner, printer, electronic payment processing device, cash tray, and credit card processing module (not shown). Elements of the POS device may be positioned on, at, or near a table surface 20 of the checkout counter 16 such as a display monitor 12, while other elements such as the processor and memory may be positioned below the table surface, for example, collocated in a compartment under the register belt 302. The garbage collection system 100 may be positioned between the POS system 12 and the register belt 16, or separate from the POS system 12 by a predetermined distance under the register belt 16. In other embodiments, the garbage collection system 100 is positioned under the table 20 in such a manner that it does not interfere with other physical elements of a checkout counter 16 such as electronic parts, wires, and so on. In some embodiments, the garbage collection system 100 may include two housing units: a first housing unit under the table 20 and holding a first bin, and a second housing unit under the register belt 14 and holding a second bin.

The self-contained unit of the garbage collection system 100, including housing 102 and door 103, may be positioned at a region 17 under the register belt 14 for ease of access and usage by a store associate behind the checkout counter. The door 103 of the system 100 may be used in lieu of a door of the counter compartment 17.

In doing so, the door 103 may be constructed and arranged to match the register belt counter 16, for example, same color, texture, material, alignment, quality, and/or shape for insertion into the counter compartment 17, and so on. The garbage bins 112, 113 may move in a linear direction in and out of a compartment 17 in a region of the counter 16 under the register belt 14 due to sliding rails 104 or the like, which extend and retract when a user pulls or pushes one or both garbage bins 112, 113 when needed. An outermost edge of the housing, the door 103, or the bins themselves may be flush with a surface of the register belt area or other regions of the counter so as to not protrude from the counter, and therefore provide a compact configuration when closed. However, when at least partially opened, for example, rails extended to expose some or all of the bins 112, 113, some protrusion may occur. The counter 16 may include a door (not shown) in an opened position when the sliding rails 104 are in an extended position, and the garbage bins 112, 113 are therefore outside of the compartment 305. The door may be in a closed position when the sliding rails 104 are in a retracted position, and the garbage bins 112, 113 are inside the compartment 305.

In some embodiments, the retail store checkout counter serves as a hybrid register, for sorting garbage from recyclables such as hangers, plastic bags etc. at the checkout counter. The garbage collection system 100 can be constructed and arranged for one or more of garbage collection, recyclable collection, hangers' collection, returns collection (for example, bottles, cans, and so on), or anything else having a size and configuration for insertion into one or both bins 112, 113.

While concepts have been shown and described with reference to specific preferred embodiments, it should be understood by those skilled in the art that various changes in form and detail may be made therein without departing from the spirit and scope as defined by the following claims.

What is claimed is:

1. A garbage collection system, comprising:
a housing positioned under a belt of a point of sale register counter;
first and second bins positioned in the housing under the point of sale register counter, the first bin for receiving garbage and/or recyclables, the second bin for receiving hangers; and
at least one sliding rail extending perpendicular from a height of the housing, the first and second bins coupled to the at least one sliding rail, at least one of the first and second bins retracting or protruding from at least a portion of the housing in a first position and positioned entirely in the housing in a second position.

2. The garbage collection system of claim 1, wherein the housing includes:
a first side;
a second side;
a back wall between the first side and the second side; and
an interior between the first side, the second side, and the back wall, wherein the first and second bins are positioned in the interior of the housing.

3. The garbage collection system of claim 2, further comprising a door at an opening to the interior of the housing.

4. The garbage collection system of claim 3, wherein the door has at least one of a same or similar color, texture, quality, or material as the sale register counter.

5. The garbage collection system of claim 2, further comprising a pair of sliding rails coupled between the door and the housing, for extending or retracting the door and the first and second bin relative to the housing.

6. The garbage collection system of claim 2, wherein the door is hinged to the housing, which when closed, hides the first and second bins in the housing.

7. The garbage collection system of claim 1, further comprising a trash bin housing unit for holding the first and second bins, the trash bin housing unit constructed and arranged for positioning in an interior of the housing.

8. The garbage collection system of claim 1, further comprising a frame for holding the first and second bins, the frame constructed and arranged for positioning in an interior of the housing.

9. The garbage collection system of claim 1, further comprising at least one fixture attachment for coupling the housing to the register counter.

10. The garbage collection system of claim 9, wherein the at least one fixture attachment includes a first fixture attachment extending from a top surface of a back wall of the housing.

11. The garbage collection system of claim 9, wherein the at least one fixture attachment includes a second fixture attachment extending from a surface of a side wall of the housing.

12. The garbage collection system of claim 1, wherein the housing is coupled to an underside of the register counter and is suspended above the ground by a predetermined distance.

13. A garbage collection system, comprising:
a housing positioned under a belt of a point of sale register counter, the housing including a first region for holding a first bin and a second region for holding a second bin;
at least one sliding rail extending perpendicular from a height of the housing; and
a housing unit or a frame coupled to the at least one sliding rail for holding the first and second bins, the housing unit or frame holding the first and second bins retracting or protruding from at least a portion of the housing in a first position and positioned entirely in the housing in a second position.

14. The garbage collection system of claim 13, wherein the first bin is constructed and arranged for receiving at least one of garbage or recyclable material, and the second bin is constructed and arranged for receiving hangers.

15. The garbage collection system of claim 13, wherein the housing includes:
a first side;
a second side;
a back wall between the first side and the second side; and
an interior between the first side, the second side, and the back wall, wherein the first and second bins are positioned in the interior of the housing.

16. The garbage collection system of claim 15, further comprising a door at an opening to the interior of the housing.

17. The garbage collection system of claim 13, wherein the housing is coupled to an underside of the register counter and is suspended above the ground by a predetermined distance.

18. The garbage collection system of claim 13, further comprising a trash bin housing unit for holding the first and second bins, the trash bin housing unit constructed and arranged for positioning in an interior of the housing.

19. The garbage collection system of claim 13, further comprising a frame for holding the first and second bins, the frame constructed and arranged for positioning in an interior of the housing.

20. A garbage collection system formed by a process, comprising:
positioning a housing under a belt of a point of sale register counter;
coupling at least one sliding rail to the register counter, the at least one sliding rail constructed and arranged to extend perpendicular from a height of the housing;
coupling a housing unit or a frame coupled to the at least one sliding rail for holding the first and second bins; and
retracting or extending the housing unit or frame from at least a portion of the housing in a first position and positioned entirely in the housing in a second position.
